(19) United States
(12) Patent Application Publication
(10) Pub. No.: US 2020/0273587 A1
(43) Pub. Date: Aug. 27, 2020

(54) METHOD AND APPARATUS FOR PORTABLE NEUTRON INTERROGATION

(71) Applicant: Mission Support and Test Services, LLC, Las Vegas, NV (US)

(72) Inventors: Brady Gall, North Las Vegas, NV (US); Nichelle Bennett, North Las Vegas, NV (US); Michael Heika, North Las Vegas, NV (US); Michael Blasco, North Las Vegas, NV (US); Joseph Bellow, North Las Vegas, NV (US); Bernard T. Meehan, North Las Vegas, NV (US); Vincent DiPuccio, North Las Vegas, NV (US)

(21) Appl. No.: 16/803,686

(22) Filed: Feb. 27, 2020

Related U.S. Application Data
(60) Provisional application No. 62/811,491, filed on Feb. 27, 2019.

(51) Int. Cl. G21B 3/00

(52) U.S. Cl. CPC G21B 3/006

(57) ABSTRACT

A portable neutron generating system for SNM inspection that includes charge storage device configured to store a high voltage electrical charge and a controller to selectively electrically connect the charge to a plasma generator. The plasma generator is configured to generate a plasma, which in turn generates neutrons, in response to the electrical charge being provided to the plasma generator. A high voltage switch is located between the charge storage device and the plasma generator and is configured to electrically discharge the high voltage charge on the charge storage device to the plasma generator. The plasma generator is removably attachable to the portable neutron generating system such that it may be easily removed from the portable neutron generating system when the gas inside the plasma generator is at end of life and a refreshed plasma generator easily connected to the portable neutron generating system.

### 2. PRIORITY CLAIM

This application is a continuation of, claims priority to and the benefit of U.S. Provisional Patent Application No. 62/811,491 filed on Feb. 27, 2019, entitled Man-Portable Dense Plasma Focus For Neutron Interrogation Applications, the contents of which are incorporated by reference in its entirety herein.

### 1. STATEMENT REGARDING FEDERAL RIGHTS

This invention was made with government support under Contract No. DE-AC52-06NA25946 and was awarded by the U.S. Department of Energy, National Nuclear Security Administration. The government has certain rights in the invention.

### 3. FIELD OF THE INVENTION

The invention relates to dense plasma focus neutron generation and in particular to a portable plasma focus neutron generator for item interrogation.

### 4. BACKGROUND

A dense plasma focus (DPF) event creates a hot, dense ionized gas (plasma) similar in nature to that at the center of the sun, but only for a brief moment. In plasma in the sun, hydrogen undergoes nuclear fusion and creates a high-energy neutron that is expelled nearly at the speed of light. Because neutrons are not electrically charged, they do not easily interact with many materials and can pass through even the densest objects, including steel and lead.

Neutrons can also travel deep within a target atom and alter the nucleus of that atom. If an object of interest contains special nuclear material (SNM), the neutron can induce small amounts of nuclear fission, which releases high-energy gammas and neutrons that act as a “fingerprint,” of the SNM allowing a detector to determine the nature of the probed material. This process is called active interrogation or interrogation and, r such like a metal detector at the airport, can be used to deter urineif and where SNM is hidden. This allows an item that may contain SNM to be interrogated externally without having to open or inspect the item, and this interrogationcan be done quickly and from a distance.

The dense plasma focus (DPF) neutron generator is known in the art. This technology, which emerged in the 1960s, is considered a relatively mature method for creating prolific, ultrashort neutron pulses. Despite this fact, few commercial or industrial options for using DPF exist. A more popular prior art option are systems that rise ion beam diodes due to their simplicity and acceptance in the industry performance.

The prior art systems, including DPF neutron generators, suffer from numerous drawbacks that limit their application and use. One such drawback to the prior art is that such systems are large and heavy, making it unsuitable for portable applications. Another drawback is that prior art devices that are not fixed in one location or that might be movable have very limited coverage and penetration. Thus, the types and size of items which can be interrogated are limited with movable prior art systems. Yet another drawback of prior art system is the speed at which they can be made operational and the speed of interrogation. For many applications, speed of operation is critical. Another drawback is the limited lifespan before service is needed, and servicing requires that the entire device be returned to a service center or that the entire device be out of service for a long period of time, thus preventing interrogation of suspect items.

To overcome the drawbacks of the prior art, a dense plasma focus (DPF) neutron generator was designed and tested. It overcomes the drawbacks in the prior art and provides additional benefits over the prior art.

### SUMMARY

To overcome the drawbacks of the prior art, a dense plasma focus (DPF) neutron generator was designed and tested, and one example embodiment thereof is disclosed below. In one embodiment, a neutron generating system for SNM inspection is provided that includes a charge storage device configured to store an electrical charge. Also part of this embodiment is a plasma generator configured to generate a plasma, which in turn generates neutrons, in response to an electrical charge being provided to the plasma generator. A controller is configured to generate an activation signal based on user input. A high voltage switch is provided which has a first terminal connected to the charge storage device and a second terminal connected to the plasma generator. The high voltage switch is responsive to the activation signal from the controller to electrically connect the first terminal to the second terminal to transfer the electrical charge from the charge storage device to the plasma generator. In this embodiment the neutron generating system is portable.

In one configuration, the charge storage device comprises one or more capacitors. The high voltage switch may comprise a thyratron type switch. It is contemplated that the controller may comprise a processor and a memory configured with non-transitory processor executable code. The plasma generator may comprise a dense plasma focus device having a cathode and an anode. In one embodiment, the plasma generator is detachable from the neutron generating system, and the neutron generating system is configured to accept a refreshed plasma generator. The system may further comprise a battery pack configured to store electrical charge and provide the electrical charge to the charge storage device.

Also disclosed is a method for generating neutrons for SNM inspection comprising installing a refreshed plasma generator in a neutron generating system and moving the neutron generating system near an item to be interrogated for nuclear material. Then, charging the neutron generating system's storage device with an electrical charge from a power source. Once charged, the system receives a control signal via a user interface to activate the neutron generating system, and, responsive to the control signal, switches the electrical charge from the charge storage device to the plasma generator. In response, the plasma generator generates a plasma which emits neutrons that are directed toward the SNM. Monitoring for gamma rays from the item may occur with a gamma ray detector.

In one embodiment, the power source is one of the following: battery, grid power, chemical reaction electrical generator, or generator. The refreshed plasma generator has had used gas replaced with new gas, but in other situations, other elements of the plasma generator may be replaced. In one configuration, the switching is performed by a high voltage thyratron switch. It is contemplated that the plasma generator, after a certain number of uses, is removeable, by a user, from the neutron generating system allowing a refreshed plasma generator to be installed on the neutron generating system. In one embodiment, the neutron generating system weighs less than 60 pounds.

Also disclosed is a portable neutron generation system for SNM inspection comprising a charge storage device configured to receive electrical current store a high voltage electrical charge. A user interface configured to receive user input from a user such that the input may include at least activation of the neutron generation system. Also part of this system is a controller configured to receive the user input and the control operation of the neutron generation system responsive to the user input. A plasma generator chamber containing a gas is also included. The plasma generator chamber includes an anode terminal and a cathode terminal. The plasma generator chamber is removably attached to the neutron generation system and is configured to generate a plasma, which in turn generates neutrons, in response to an electrical charge from the charge storage device being provided to the plasma generator. To conduct the charge from the charge storage device to the plasma generators, a high voltage switch is an electrically connected to the plasma generator and the charge storage device.

In this embodiment, the charge storage device may comprise one or more capacitors. The high voltage switch may comprise a thyratron high voltage switch. The controller may comprise either a processor and a memory configured with non-transitory processor executable code, control logic, or both. It is contemplated that the gas is deuterium or a deuterium-tritium mixture. In one embodiment, the plasma generator is detachable from the neutron generating system and the neutron generating system is configured to accept a refreshed plasma generator. In one embodiment, the system further comprises a battery pack configured to store electrical charge and provide the electrical charge to the charge storage device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an example environment of use of the neutron generator disclosed herein.

FIG. 2 illustrates an exemplary interrogation process.

FIG. 3 illustrates a block diagram of an example embodiment of a portable neutron generator.

FIG. 4A illustrates a side perspective view of an example implementation of the neutron generator system.

FIG. 4B illustrates cut away perspective view of an example implementation of the neutron generator system.

FIG. 5 illustrates an example embodiment of a plasma generator that generates neutrons.

FIG. 6A and FIG. 6B illustrate an exemplary plasma generator during plasma generation in the form of a dense plasma focus device.

FIG. 7A illustrates an exemplary plot of neutron output by a prior art neutron generator.

FIG. 7B illustrates an exemplary plot of neutron output by the neutron generator disclosed herein.

FIG. 8 illustrates a plot of X-ray and neutron pulses from a neutron generation system as described herein.

FIG. 9A and FIG. 9B illustrate a plasma source module which is attachable and removable from the neutron generator system.

FIG. 10 illustrates an operational flow chart of an example method of operation of the neutron generator and SNM interrogation.

### DETAILED DESCRIPTION

To overcome the drawbacks of the prior art, disclosed is a dense plasma focus (DPF) neutron generator that is a portable, high-output neutron generating device capable of reliable detection of special nuclear materials (SNM) in any environment, including, remote or emergency response settings. In one embodiment, the neutron generator produces an average of 5×10⁷ neutrons per pulse using fuel, such as deuterium, and can be operated with a 5-second repetition rate. In this embodiment, the DPF weighs approximately 50 lbs. and is compatible with standard utility hookups and battery power. In other embodiment, other operating parameters are possible. Using this system an object suspected to contain SNM may be inspected using generated gamma or neutron radiation fields. By examining the response products emitted from the object, its internal composition and configuration may be ascertained. For many reasons, it is not practical for test objects to be brought to a central location for inspection. Therefore, a reliable, high-flux neutron source, as disclosed herein, that can be brought to the object's location is an improvement as compared to prior art systems and very useful for sensing and locating hidden SNM objects. The disclosed neutron source produces 10⁶ or more neutrons per second, is portable and rugged, and is simple to operate in the field. Furthermore, DPF systems can be made quite compact, enabling mobile operation. With the ability to generate high amplitude, short pulse-width neutron fields in a readily transportable form factor, the disclosed DPF based neutron generator is well suited to portable active interrogation applications.

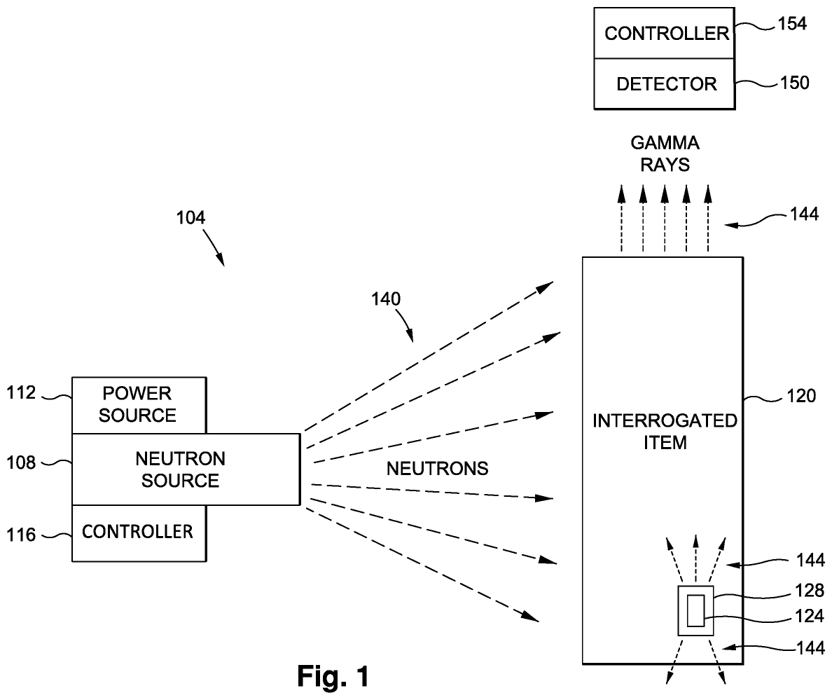

FIG. 1 illustrates an example environment of use of the neutron generator disclosed herein. This is but one possible environment of use. In this environment of use, there is an item 120 to be interrogated to determine if the item has any SNM 124 within the item. The SNM 124 may be hidden within the item 120 and may have shielding 128 around it. Therefore, it can be difficult, costly, dangerous, and time consuming to inspect the item 120 by hand to determine if it contains SNM 124. In various situations, the item could be a shipping container, boat, suspected bomb, package, backpack, automobile, box, truck, storage unit, room, or any other type container, package or enclosed space.

To interrogate the item 120, a portable neutron generator 104 is provided. The portable neutron generator 104 includes a neutron source 108, a power source 112 and a controller 116. Each of these elements is discussed below in greater detail. The neutron generator 104 outputs and directs a burst of neutrons 140 toward the item 120. The neutrons pass through the item 120 and in doing so also pass through and strike the SNM 124. Neutrons encountering the SNM 124 cause the SNM to emit gamma rays 144. The gamma rays exit the item 120 and can be detected by a detector 150. Other types of emissions are possible, such as neutrons. The detector 150 operates in conjunction with a controller 154 to provide an output to a user when gamma rays 144 or other type emissions are generated by the item 120 after interrogation, thus indicating the presence of SNM 124 inside the item.

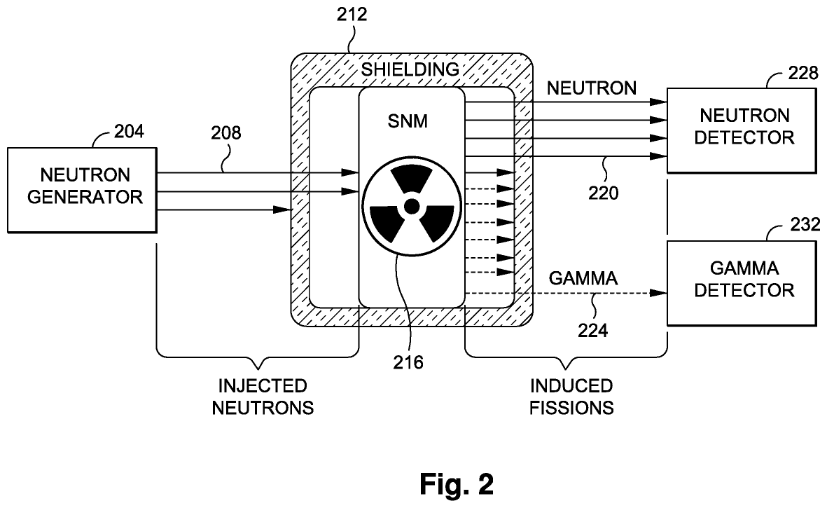

FIG. 2 illustrates an exemplary interrogation process. As shown, a neutron generator 204 operates to generate neutrons 208 which are directed to the SNM 216. The SNM 216 may be surrounded by shielding 212 in an attempt to hide or conceal the SNM. As the neutrons 208 from the neutron generator pass through the shielding 212, they strike the SNM 216. In response, the neutrons induce fission in the SNM 216 which leads to emission of neutrons 220 and gamma rays 224 from the SNM. The emitted neutrons 220 easily pass through the shielding 212 and are recorded by a neutron detector 228. A large percentage of the emitted gamma rays are absorbed by the shielding 212 but a portion of the gamma rays 224 pass through the shielding and strike a gamma ray detector 232. A large percentage of the emitted neutrons from the SNM 216 pass through the shielding 212 and strike a neutron detector 228. The gamma ray detector 232 and neutron detector 228 provide an output or alert to a user in response to detection of neutrons or gamma rays. Neutrons from the DPF can be distinguished from the SNM-generated neutron population using a variety of methods, in particular, time-gating and spectral discrimination. Time-gating requires knowledge of when the DPF fires and accounts for the known propagation time from the DPF to the detectors and can be precisely determined prior to the introduction of SNM. DPF neutrons will reliably only appear at the same time relative to the signal sent to initiate the neutron pulse, therefore, any neutrons that appear outside this window are far more likely to be generated from fission at the SNM target. Similarly, the neutron energy emitted from the DPF is precisely known depending on the fuel: either 2.45 MeV for the pure deuterium fuel or 14.1 MeV for the mixture of deuterium and tritium. Neutrons emitted from the SNM object also have characteristic energies associated with them, therefore a neutron detector with the ability to sense the neutron energy can differentiate a DPF-generated neutron from an SNM-generated neutron. This is but one possible arrangement and other configurations are possible and contemplated.

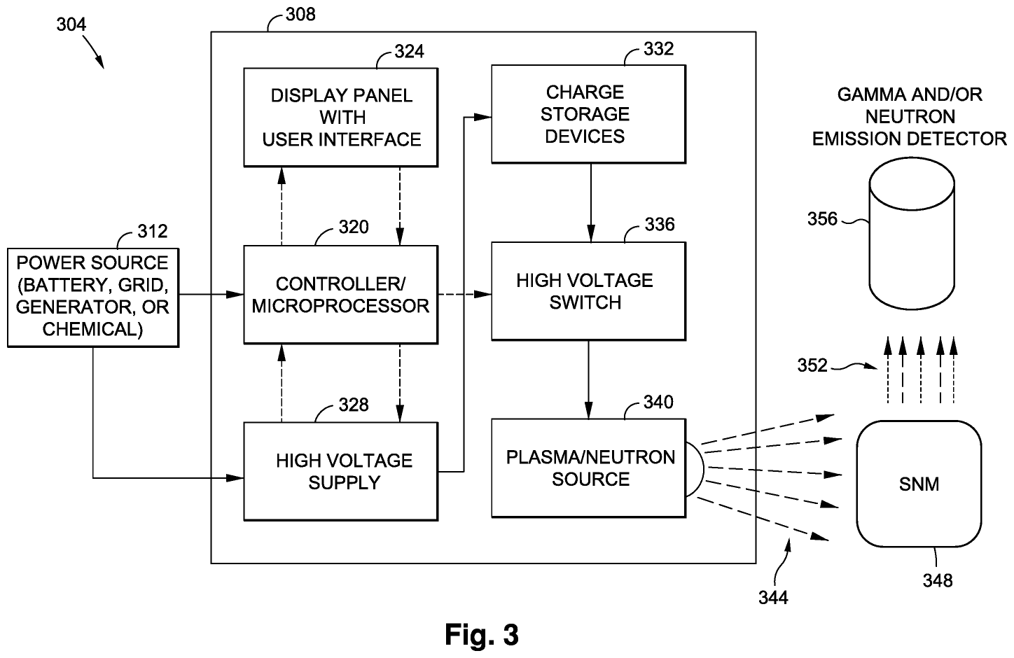

FIG. 3 illustrates a block diagram of an example embodiment of a portable neutron generator. As shown in this example embodiment, a neutron generator system 308 is provided as a self-contained unit with numerous elements contained therein. A power source 312 may be externally provided or integrated with the neutron generator system. The power source 312 may be any type power source including but not limited to a battery, grid based power, wired connection, any type electrical generator, charge storage device, or chemical source electrical power. In one embodiment the power source comprises a battery charged by a wired power source such as from a power grid.

Forming the neutron generator system 308 is a controller 320 which may include a microprocessor. The controller 320 oversees operation of the neutron generator system 308 including the user activate and activation of the neutron generation. The controller may comprise any type of control unit capable of performing the control functions described herein, including but limited to a processor, ASIC, logic elements, DSP, switch system or any other system or device. The controller 320 receives power from the power source 312. In FIG. 3 the dashed lines represent control signals while the solid lines indicate paths which conduct voltage and current. In one embodiment, the controller comprises a processor configured to execute machine readable instructions or processor executable code which is stored on a memory that can be accessed by the processor.

The controller 320 is in communication with a user interface 324 that may include a display panel. The user interface 324 receives input from a user and provides information to a user. The user interface 324 may comprise one or more buttons, keyboards, knobs, screen, lights, wheels, speakers, or any other user interface. The system may be controlled remotely, such as by a wired, wireless, or optic communication channel.

The controller 320 is also in communication with a high voltage supply module 328. The high voltage supply module 328 receives power from the power source 312 and steps up the voltage to a higher voltage. In one embodiment, the high voltage supply module 328 comprises a driver which steps up the voltage from the power supply 312 to a much higher voltage, such as to 25 kilovolts. In other embodiments, other voltage step up ranges may be utilized. The neutron generator disclosed herein operates at relatively low voltage (25 kV) compared to commercial fixed location generators that typically operate at about 100 kV. This reduces the electrical shock hazard to the end user. It also eliminates the need for sulfur hexafluoride (SF6), which many commercial. generators use for high-voltage insulation. SF6 is an asphyxiant that must be removed to ship the generator.

The high voltage supply module 328 connects provides the stepped-up voltage to one or more charge storage devices 332. In one embodiment, the charge storage devices 332 comprise one or more capacitors modules which may be evenly spaced around the neutron source 340 to provide geometrically even charge distribution. In one embodiment, the charge storage devices 332 comprise capacitors modules with a total capacitance of 3.0 microfarads and it takes 0.5 to 30 seconds to charge the capacitors to full voltage. The amount of time may correspond to the size and rated power of the power supply. Larger power supplies will charge the capacitor bank faster, but will be heavier, take up more room, and have special utility hookup requirements, so a manufacturer could have a line of different units including ultra-portable but slower-to-charge, bulkier but faster to charge, or a design that is a compromise between size and charge speed.

Between the charge storage devices 332 and the neutron source 340 is a high voltage switch 336. In one embodiment, the high voltage switch comprises a cold-cathode thyratron switch. However, in other embodiments, other type switch or connection devices may be used. The high voltage switch 336 is a device for quickly and uniformly transferring the charge from the charge storage devices 332 to the neutron source 340. Any type switch may be used that is capable of rapidly transferring the charge to the neutron source 340. The high voltage switch is controlled by the controller 320.

The neutron source 340 may comprise any device capable of generating and outputting neutrons. In the configuration described herein, the neutron source comprises a dense plasma focus neutron generator that is shown and discussed in greater detail below. The neutron source 340 generates and outputs neutrons 344 which are directed to an item which may contain SNM 348. If an SNM is present, upon being bombarded with neutrons 344, it will emit gamma rays and additional neutrons 352. The gamma rays and additional neutrons 352 are detected by a detector 356 and any detections are reported to a user thus indicating the presence of SNM 348.

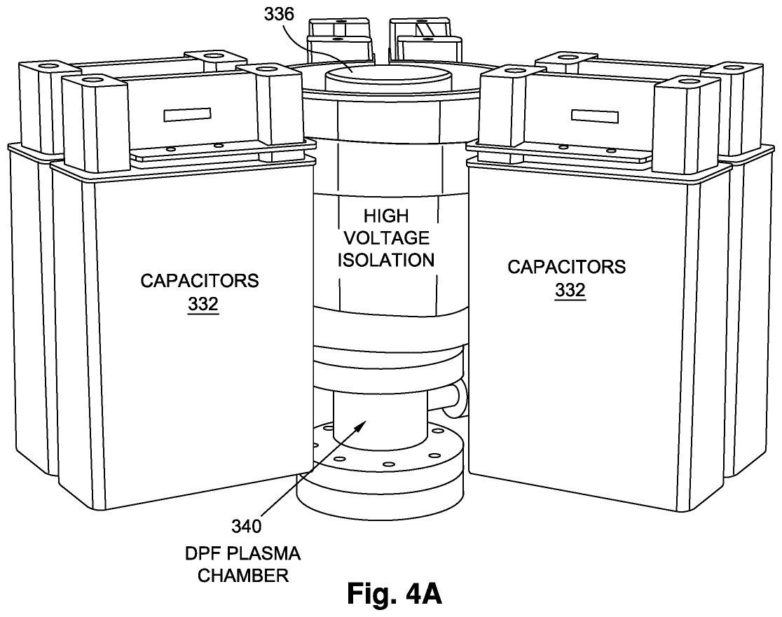

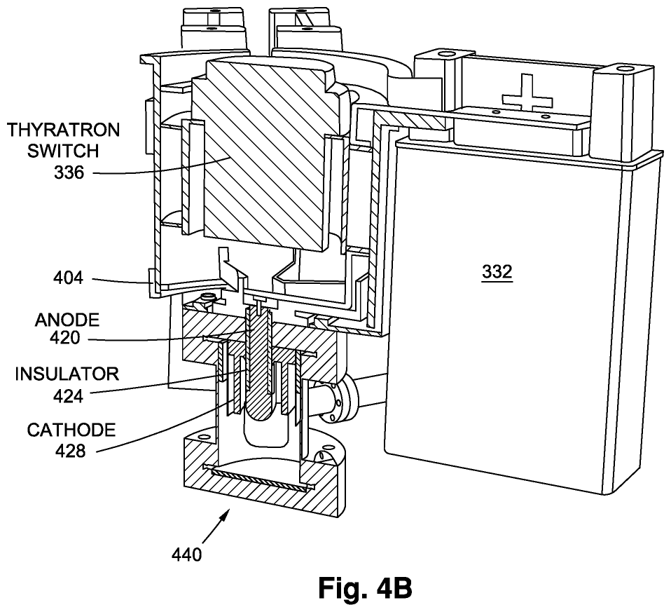

FIG. 4A illustrates a side perspective view of an example implementation of the neutron generator system. FIG. 4B illustrates cut away perspective view of an example implementation of the neutron generator system. Both figures are described in the following discussion. It should be noted that the layout shown in FIG. 4A and 4B is but one possible arrangement of the elements of FIG. 3 and the claims are not limited to this particular layout. Elements shown in FIGS. 4A, 4B which are also shown in FIG. 3 are not discuss in detail again.

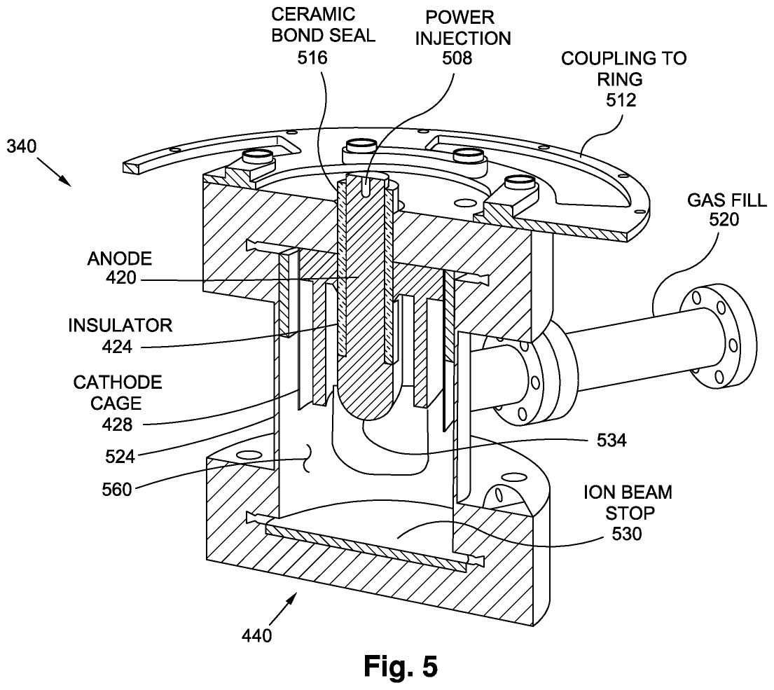

Spaced at generally equal distance apart are three capacitor modules (charge storage devices 332) which store electrical charge. Conductive power buses (not shown) electrically connect the capacitors modules to the switch 336. An outer housing 404 encloses the switch 336 and the electrical connections between the switch and the capacitors. Located below the switch is the plasma generator 340 that generates the neutrons. The plasma generator 340 includes an anode 420, an insulator 424 and a cathode 428. The neutrons are emitted outward from the end 440 of the plasma generator 440. The plasma chamber is discussed in FIG. 5 in detail.

FIG. 5 illustrates an example embodiment of a plasma generator that generates neutrons. This is but one possible example configuration of the plasma generator, and it is contemplated that the claims that follow are not limited to this particular layout. The plasma generator 340 includes a housing 524 that creates an inner space defined herein as the chamber 560. In the chamber 560 is the anode 420, insulator 424, and a cathode 428. A power injection port 508 is at a first end of the anode 420. The second end 534 of the anode 420 is with chamber 560. Electrically separating anode 420 and the cathode 428 is the insulator 424.

A ceramic bond seal 516 prevents air or other gases from entering the chamber 560 when a vacuum is established within the chamber or when other gases are placed within the chamber. A gas fill port 520 is provided to establish a vacuum within the chamber 560 and thereafter to fill the chamber with gas. The gas that fills the chamber is referred to herein as fuel and is discussed below in greater detail.

A coupling ring 512 is part of the electrical return path and is configured to electrically connect the negative terminals of the capacitors (charge storage devices) to the chamber. The switch selectively electrically connects the charge storage device to the plasma generator and in particular, the anode 430.

The plasma is formed at the second end 534 of the anode 420. The neutrons exit in all directions, including the end 440 of the chamber 560, radiating outward from the plasma. Inside the chamber 560, at the end 440, is an ion beam stop 530. The ion beam stop 530 is exposed to the plasma and resultant ion beam which propagates from the second end 534 toward the ion beam stop 530. The plasma temperature can approach the temperature of the sun and as such is a severe environment which can corrode or break down the inner surface of the chamber 560, and in particular the area covered by the ion beam stop 530. Over time this will degrade the inner surface of the end 440 and the degraded surface will transfer to other areas within the chamber 560. This transfer with degrade operation of the plasma generator and reduce neutron output. The ion beam comprises ionized fuel gases and is a byproduct of the plasma compression process. The ion beam has sufficient energy to ablate the inner surface of an ion beam stop 530 which introduces molecular contaminants from 530 into the chamber, which pollutes the chamber and reduces performance. The ion beam stop 530 is placed on the inner side of the end 440. The ion beam stop 530 is formed from either copper or molybdenum, which have a proven history resisting the ablation effects, ensures sustained, high fidelity DPF operation. The ion beam stop 530 resists degradation from repeated ion beam exposure.

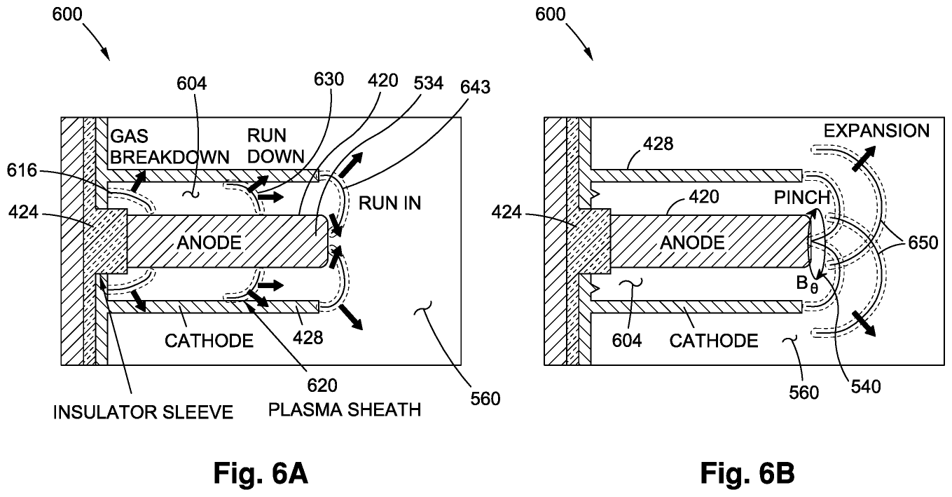

FIGS. 6A and 6B illustrate an exemplary plasma generator during plasma generation. Shown is a dense plasma focus device 600. In FIG. 6A, the anode 420 is radially surrounded at 360 degrees and spaced away from the cathode 428. The space between the anode 420 and the cathode 428 is referred to herein as the gap 604. The gap 604, in a cross section side view, would appear as two concentric rings formed by the anode 420 at the center and the cathode 428 at the outer edge. Between the anode 420 and the cathode 428 is an insulator 424. The gap 604 and the entire chamber 560 is filled with a gas, which may be referred to as fuel. In one embodiment, the chamber 560 is filled to a very lower pressure, about 10 torr, or roughly 1% of atmospheric pressure. In other embodiments, other pressures may be selected.

The DPF device 600 is a coaxial accelerator with a blunt anode termination at the second end 534. The chamber 560 is filled with a low-density gas, typically deuterium (labeled DD for the interacting ions) or a deuterium-tritium (DT) mixture. As the current from the capacitor(s) is switched to the anode to form an electrical pulse, the gas is ionized and accelerated through the j×B force to the second end of the anode 534. The plasma pinches at the anode tip with sufficient velocity to create neutrons by fusion processes.

DPF operation is categorized into four phases, shown in FIGS. 6A and 6B. The gas ionizes 616 in the first phase with the arrival of a high-voltage pulse. The conductivity increases rapidly as the current-carrying plasma sheath 620 is formed. As the current rises and the j×B force increases, the plasma sheath is accelerated to the end 534 of the anode 420. This second phase is referred to as run-down 630 . The third phase, or run-in 634, occurs after the plasma sheath reaches the end 534 of the anode 420 and is accelerated radially inward. In the pinch phase 640, the plasma densities and temperatures (energies) have increased sufficiently to enable fusion reactions. Neurtrons 650 radiate outward from the plasma pinch 640.

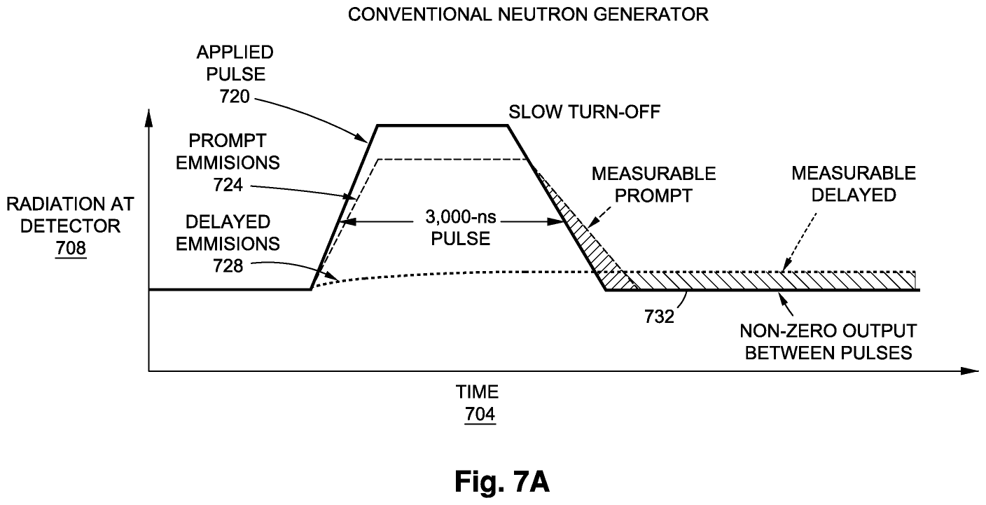

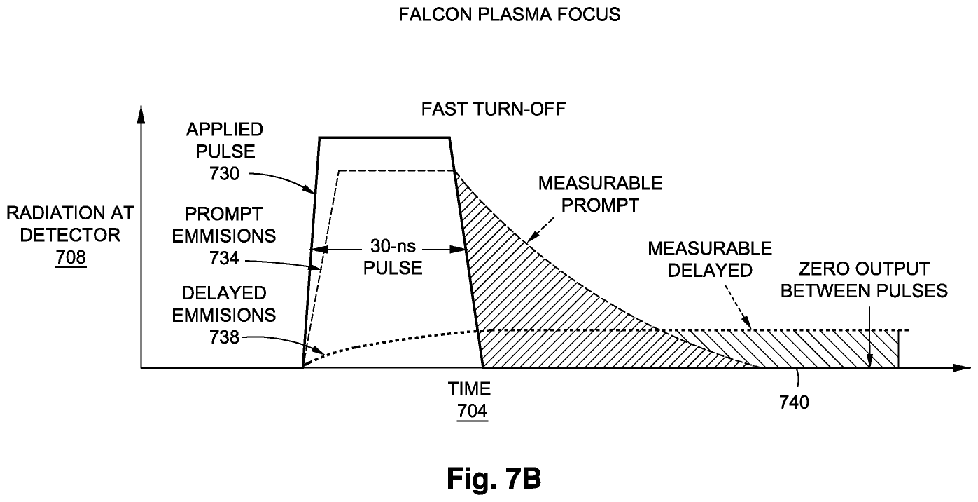

FIG. 7A illustrates an exemplary plot of neutron generation by a prior art neutron generator. This is but one possible plot from one exemplary prior art neutron generator. The horizontal axis 704 represents time while the vertical axis 708 represents radiation at a detector. Shown in the plot is an applied pulse 720 of electrical current, prompt neutron emissions 724, and delayed neutron emissions 728. As can be seen, the ramp-up time of the pulse and emissions is slow and the pulse width is a about 3000 nanoseconds. In addition, the plot of the prompt neutron emissions 724 and applied electrical pulse 720 have a slow turn-off time. Furthermore, there is an unwanted non-zero output 732 between pulses and neutron generation which is undesirable since it adds to background noise and reduces the clean delineation between a neutron pulse and background levels.

FIG. 7B illustrates an exemplary plot of neutron generation by the neutron generator disclosed herein. This is but one possible plot from an exemplary neutron generator as disclosed herein. The horizontal axis 704 represents time while the vertical axis 708 represents radiation at a detector. Shown in the plot is applied pulse 730 of electrical current, prompt neutron emissions 734, and delayed neutron emissions 738. As can be seen, the ramp-up time of the pulse and emissions is faster than in the prior art and the pulse width is reduced to only 30 nanoseconds, a 100 times improvement. In addition, the plot of the prompt neutron emissions 734 and applied electrical pulse 730 have a faster turn-off time as compared to the prior art. Furthermore, there is a non-zero output 740 between pulses and neutron generation which is undesirable since it adds to background noise and reduces the clean delineation between a neutron pulse and background levels.

Both continuous and pulsed modalities can be used to detect SNM, however pulsed sources offer additional functionality. In particular, pulsed sources can be used to measure target-generated gamma die-away from fission multiplication, augmenting the capability of an SNM sensing platform. Short pulses, such as that shown in FIG. 7B, increase the fidelity of this measurement and are therefore preferable for this application. The dense plasma focus as described herein can produce pulses up to 10,000 times shorter than the prior art generators, such as the MP 320 neutron generator, available from Thermofisher

Scientific which may be contacted at www.thermofisher.com, and also maintains a comparable time-average neutron flux.

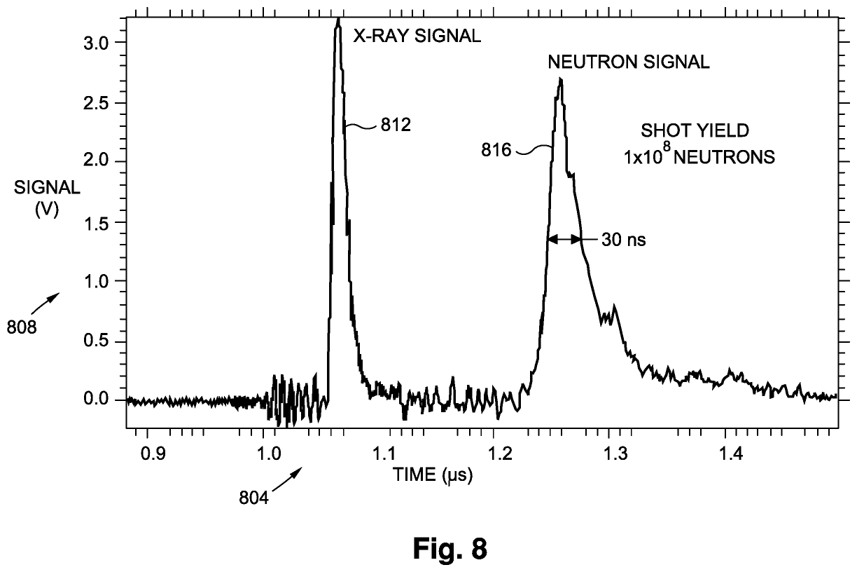

FIG. 8 illustrates a plot of X-ray and neutron pulses from the neutron generation system described herein. The horizontal axis 804 represents time while the vertical axis 808 represents the signal form the detector. The pulse 812 of the plot represents x-rays (x-ray pulse) while the pulse 816 represents neutrons (neutron pulse). The detector is placed 4 meters from the plasma pinch. X-rays and neutrons are produced simultaneously, but due to the difference in their velocities, the two pulses 812, 816 separate from each other over time. In the figure, the x-ray pulse 812 is only about 10 ns in duration, whereas the neutron pulse 816 is 30 ns measured mid-height of the pulse. The neutron pulse 816 is about 1% the duration of a conventional neutron generator pulse but contains about 1000 times the total number of neutrons. This is a significant improvement over the prior art neutron generators.

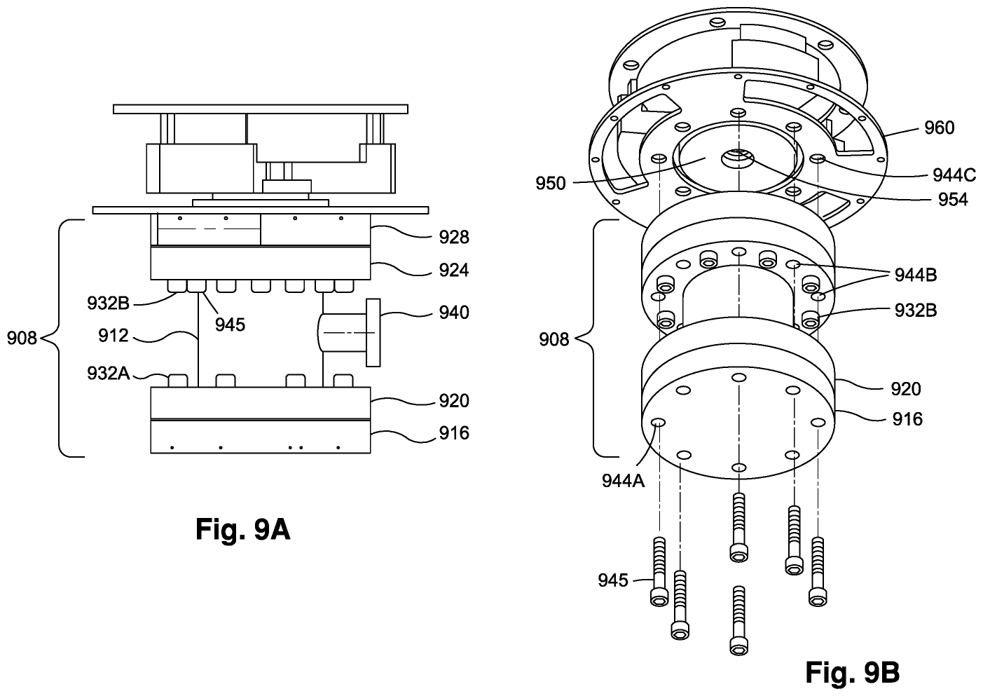

FIG. 9A and FIG. 9B illustrates a plasma source module which is attachable and removable from the neutron generator system. FIGS. 9A and 9B are discussed below in unison. The plasma source module 908 is removable and reattachable to the neutron generator system thereby allowing the plasma source module to be easily removed from the system plate 960, returned to the factory for servicing, while a renewed plasma source module may be immediately installed thereby avoiding any downtime of the system. This is a significant advantage over the prior systems which were not portable and did not have a removable plasma source module 908, thus requiring that the system be completely non-operational while the plasma generation unit was periodically serviced.

The plasma source module 908 attaches to a plate 960 that is part of the neutron generator system. In this embodiment, the plate 960 includes one or more threaded bolt holes 944C into which bolts 945 are secured. The bolts 945 extend through holes 944A, 944B and into threaded holes 944C. This secures the plasma source module 908 to the neutron generator system. By removing the bolts 945 that connect to the plate 960, the plasma source module 908 is easily removed from the neutron generator system. A renewed plasma source module 908 can quickly be installed by attaching it with the bolts 945. Although shown as being attached with bolts, it is contemplated that clamps, screws, a twisting locking mechanism, or any combination of these elements or any known or future developed attachment and detachment mechanism may be used.

Renewing the plasma source module 908 may comprise replacing the gas (fuel) contained inside the chamber, or replacing other elements inside the chamber of the plasma source module. It is also contemplated that the plasma source module 908 may be re-fueled through the gas port 940 without removal of the entire plasma source module.

Turning now to the structure of the plasma source module 908, the center area is the chamber housing 912 that includes the gas port 940. The lower plates 916, 920 include outer lower plate 916 and inner lower plate 920 which connect using bolts 932A or any other connection means such as clamps, screws, a twisting locking mechanism, or any combination of these elements. It is also contemplated and disclosed that a single-use factory-sealed hermetic chamber may be used. This would eliminate the reusability aspect of the module 908, but might have advantages in upfront cost or manufacturing complexity.

The outer lower plate 916 is removable from the inner lower plate 920 by removing the bolts 932A to provide access to the internal structure of the chamber where the anode and cathode are located. In addition, access to the ion beam stop 530 (FIG. 5) is also provided by removal of the outer lower plate 916. The bolts 932A may connect from the top of bottom of the plates 916, 920 or the top as shown in FIG. 9A.

The plasma source module 908 also has upper plates 924, 928. The upper plates 924, 928 include an outer upper plate 928 and an inner upper plate 924. The outer upper plate 928 seals the chamber to prevent the escape of the gas (fuel) when the plasma source module 908 is not connected to the plate 960. Bolts 932B secure the plasma source module 908 to the plate 960 by connecting to bolt holes 944C.

Also part of the plasma source module 908 are electrical connections between the plasma source module 908 and the system. On the plate 960 is a cathode connection plate 950 and an anode connection port 954 which connect to corresponding conductors on the plasma source module 908.

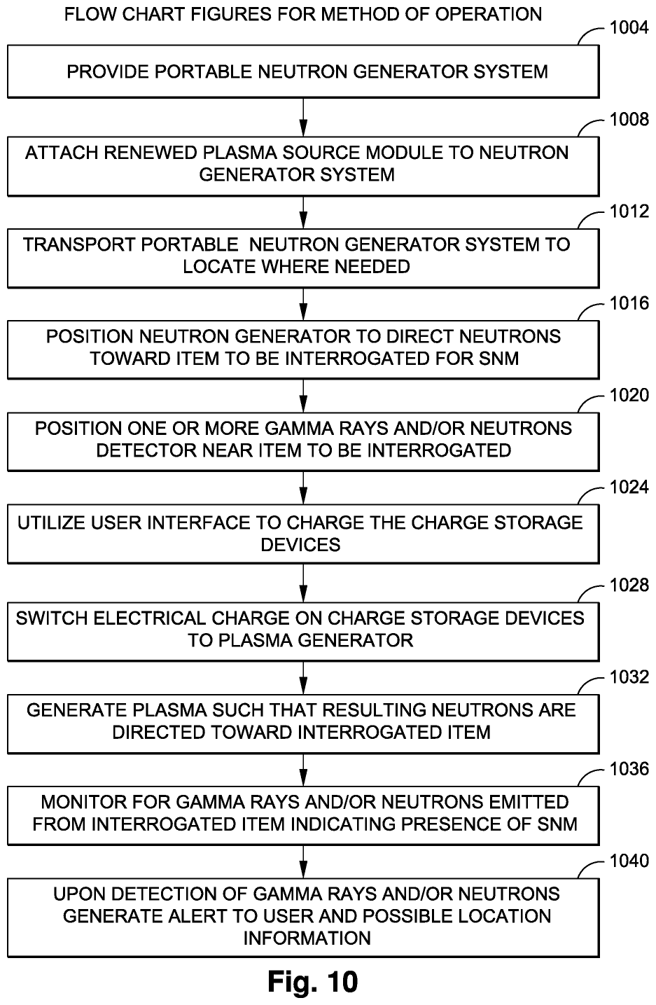

FIG. 10 illustrates an operational flow chart of an example method of operation of the neutron generator and SNM interrogation. This is but one possible method of operation and it is contemplated that other methods of operation are possible which do not depart from the claims. At a step 1004, a portable neutron generator system is provided. This system operates to generate neutrons. At a step 1008 a renewed plasma source module is attached to the neutron generator system. The plasma source module is described in FIG. 9 along with the renewal processes. The plasma source module may be removed from the system from servicing.

At a step 1012, a user or other personnel, transports the portable neutron generator system to a location where it is needed. As described above, the location may be any location where an item to be interrogated is located. The item to be interrogated may contain SNM. Next, at a step 1016 the neutron generator system is positioned to direct neutrons toward the item to be interrogated to determine if the item contains SMN. Because the neutron generator system is portable, it can be driven, flown, or carried to any location for item interrogation. At a step 1020, one or more gamma ray detectors and/or neutron detectors are positioned near item to be interrogated and activated for monitoring. The gamma ray detectors and/or neutron detectors are also portable.

At a step 1024 a user of the neutron generator system utilizes the user interface to charge the charge storage devices. The electrical power to charge the charge storage devices may be from any source, such as a wire connect to a power grid, a generator, batteries, or any other source. Next, at a step 1028, after the charge storage devices are charged, the user connects, through a switching operation, the power from the charge storage devices to the plasma generator. Discharging the power from the charge storage devices to the plasma generator causes a plasma event within the plasma generator and the generation and emission of neutrons from the plasma generator. This occurs at a step 1032. The neutrons are emitted from the plasma generator and encounter the interrogated item.

At a step 1036, monitoring occurs for emitted gamma rays and/or neutrons by the detectors positioned near the item. Emission of gamma rays and/or neutrons from the item in response to neutrons from the plasma source indicates that the interrogated item contains an SNM. At a step 1040, upon detection by the one or more detectors, of emitted gamma rays and/or neutrons, an alert is generated and provided to the user of the presence of SNM and the location of the SNM in the item.

### Implementation Example

The following describes one exemplary implementation. The system and claims that follow are not limited to the following implementation example. In this implementation, the goal was to design and build a portable neutron generator. The result was a successful and repeatable demonstration of neutron output with an average yield of 5×10⁷ neutrons per pulse and a pulse width of approximately 30 ns full width half maximum.

As part of the discussion of the example implementation, a brief overview of the basic principles of the dense plasma focus is presented, followed by the exemplary mechanical design of the pulsed power driver and plasma source. The third section details the experimental configuration and diagnostics used to measure the electrical and radiological output of the plasma generator. Section four details the experimental results of this measurement.

### Dense Plasma Focus Operational Principle

The DPF device selected for this implementation is a coaxial accelerator with a blunt anode termination that is filled with a low-density gas, typically deuterium (labeled DD for the interacting ions) or a deuterium-tritium (DT) mixture. As the accelerator is pulsed, the gas is ionized and accelerated through the j×B force to the end of the anode. The plasma pinches at the anode tip with sufficient velocity to create neutrons by fusion processes.

DPF operation is categorized into four phases (see FIGS. 6A, 6B). The gas ionizes in the first phase with the arrival of a high-voltage pulse. The conductivity increases rapidly as the current-carrying plasma sheath is formed. As the current rises and the j×B force increases, the plasma sheath is accelerated to the end of the anode. This second phase is referred to as run-down. The third phase, or run-in, occurs after the plasma sheath reaches the end of the anode and is accelerated radially inward. In the pinch phase, the plasma densities and temperatures (energies) have increased sufficiently to enable fusion reactions.

### Design of the Portable Dense Plasma Focus

The simulations of the DPF were performed using the fully relativistic electromagnetic particle-in-cell code Chicago, from the developers of LSP (Welch, Rose, Oliver, & Clark, 2001) and nine different geometries were tested. A non-comprehensive matrix of various metrics was explored, including anode terminal shape (flat, hemispherical, toroidal, and with/without hole), anode length (4, 5, and 7 cm) gas pressure (2, 6, and 6.5 torr) and insulator thickness (2 and 4 mm). Of these parameters, the top performer in terms of total neutron output was the 5 cm anode, 2 mm insulator, hemispherical anode with a hole, and 6 torr fill pressure, producing 1.1×10⁸ neutrons per pulse.

This system used the dimensions determined from modeling for the top performing design. One challenge in implementing the plasma process chamber was negotiating the high voltage penetration into the vacuum envelope. The high voltage anode must protrude into the vacuum chamber without touching or approaching the metal walls of the chamber itself. Failure in this will lead to high voltage breakdown in air or surface flashover which will prevent the desired plasma process from occurring. In this approach, the anode was inserted into a hollow cylinder (insulator) made from a high dielectric strength material, such as ceramic or glass, which then was inserted into an aperture in the vacuum chamber wall. Two to three thousandths of an inch (mils) of clearance between surfaces of nested components was found to be sufficient to allow for assembly and provide o-ring compression for vacuum competence. High vacuum grease was applied to the o-rings prior to assembly for added vacuum standoff. Indium, a soft, conductive metal, was inserted in between all metallic interfaces to reduce electrical losses.

The vacuum chamber was a 4.5-inch CF nipple custom ordered from vacuum component vendor. A CF connection on one port provides vacuum and thereafter deuterium fill. The anode and cathode comprised oxygen-free copper and were held in place using 6-32 bolts. Three insulator materials are contemplated, including borosilicate glass (Pyrex), glass mica (Macor), and boron nitride. In general, Pyrex is inexpensive, but cannot be easily machined, so each specimen can vary in radius. Macor and boron-nitride can be precisely machined but are more expensive. Macor is also significantly more rugged than either Pyrex or boron nitride, which is a noteworthy benefit for portable applications. The copper, glass, and ceramic materials were commercial off-the-shelf purchases from McMaster-Carr which can be contacted at www.mcmaster.com. The Rogowski coil was held in place using acrylic cup fabricated in-house using the FormLabs Form2 stereolithography rapid prototyping platform.

The assembly of the DPF plasma chamber coupled to the pulsed power driver includes a radial arrangement of six General Atomics 31150 0.5 μF, 30 kV capacitors which were used to drive the high current pinch. A Pulsed Power Solutions TDI4-100k/45H cold cathode thyratron was used for plasma switching and was centrally located in the capacitor bank arrangement. The DPF chamber coupled to the thyratron using ⅛-inch aluminum plates that were cut to specification using a water jet cutter. A combination of mylar sheets, Kapton tape, and KonForm AR acryillic conformal coating spray were used for electrical insulation. The specifics of the control system were detailed in last year's report and consisted of a LabView based I/O platform and an Ultravolt 250 W, 30 kV DC power supply.

### Results

The following is based on actual testing and measured neutron yield for a sequence of 38 shots executed using the portable DPF system. This example configuration used a charge voltage of 25 kV, fill pressure of 5.25 torr deuterium, and a Pyrex insulator sleeve. The chamber was evacuated to a base pressure of 1×10⁻⁵ torr and refilled with deuterium gas after every ten shots. A maximum yield of 6.56×10⁷ was measured early in the sequence and the average yield of the shots that successfully produced neutron yield was 2.5×10⁷.

What is claimed is:

1. A neutron generating system for SNM inspection comprising:
a charge storage device configured to store an electrical charge;
a plasma generator configured to generate a plasma, which in turn generates neutrons, in response to an electrical charge being provided to the plasma generator;
a controller configured to generate an activation signal; and
a high voltage switch, having a first terminal connected to the charge storage device and a second terminal connected to the plasma generator, the high voltage switch, responsive to the activation signal from the controller, electrically connect the first terminal to the second terminal to transfer the electrical charge to the plasma generator, wherein the neutron generating system is portable.

2. The system of claim 1 wherein the charge storage device comprises one or more capacitors.

3. The system of claim 1 wherein the high voltage switch comprises a thyratron type switch.

4. The system of claim 1 wherein the controller comprises a processor and a memory configured with non-transitory processor executable code.

5. The system of claim 1 wherein the plasma generator comprises a dense plasma focus device.

6. The system of claim 1 wherein the plasma generator is detachable from the neutron generating system and the neutron generating system is configured to accept a refreshed plasma generator.

7. The system of claim 1 further comprising a battery pack configured to store electrical charge and provide the electrical charge to the charge storage device.

8. A method for generating neutrons for SNM inspection comprising:
installing a refreshed plasma generator in a neutron generating system;
moving the neutron generating system near an item to be interrogated for nuclear material;
charging a charge storage device of the neutron generating system with an electrical charge from a power source;
receiving a control signal via a user interface to activate the neutron generating system;
responsive to the control signal, switching the electrical charge from the charge storage device to the plasma generator;
the plasma generator, responsive to the electrical charge, generating a plasma which emits neutrons that are directed toward the SNM; and
monitoring for gamma rays from the item with a gamma ray detector.

9. The method of claim 8 wherein the power source is one of the following: battery, grid power, chemical reaction electrical generator, or generator.

10. The method of claim 8 wherein a refreshed plasma generator has used gas replaced with new gas.

11. The method of claim 8 wherein switching is performed by a high voltage thyratron switch.

12. The method of claim 8 wherein the plasma generator, after a certain number of uses, is removeable from the neutron generating system allowing a refreshed plasma generator to be installed on the neutron generating system.

13. The method of claim 8 wherein the neutron generating system weighs less than 60 pounds.

14. A portable neutron generation system for SNM inspection comprising:
a charge storage device configured to receive electrical current store a high voltage electrical charge;
a user interface configured to receive user input from a user, the input including at least activation of the neutron generation system;
a controller configured to receive the user input and the control operation of the neutron generation system responsive to the user input;
a plasma generator chamber containing a gas and also including an anode terminal and a cathode terminal, the plasma generator chamber removably attached to the neutron generation system and is configured to generate a plasma, which in turn generates neutrons, in response to an electrical charge from the charge storage device being provided to the plasma generator; and
a high voltage switch electrically connected to the plasma generator and the charge storage device.

15. The system of claim 14 wherein the charge storage device comprises one or more capacitors.

16. The system of claim 14 wherein the high voltage switch comprises a thyratron high voltage switch.

17. The system of claim 14 wherein the controller comprises either a processor and a memory configured with non-transitory processor executable code, control logic, or both.

18. The system of claim 14 wherein the gas is deuterium or a deuterium-tritium mixture.

19. The system of claim 14 wherein the plasma generator is detachable from the neutron generating system and the neutron generating system is configured to accept a refreshed plasma generator.

20. The system of claim 14 further comprising a battery pack configured to store electrical charge and provide the electrical charge to the charge storage device.
